(19) United States
(12) Patent Application Publication
(10) Pub. No.: US 2005/0044148 A1
(43) Pub. Date: Feb. 24, 2005

(54) Method and system for accessing multiple types of electronic content

(75) Inventors: Sukmin ( Kevin) Son, Redmond, WA (US); Ian H. Todd, Seattle, WA (US); Kimberly J. Rush, Seattle, WA (US); Matthew R. Labarge, Kirkland, WA (US); Michael C. Crandall, Bellevue, WA (US); Julian R. Parish, Paris (FR)

Correspondence Address: Ronald M. Anderson;Law Offices of Ronald M. Anderson, Suite 507, 600 108th Avenue N.E., Bellevue, WA, 98004, US

(73) Assignee: Microsoft Corporation, Redmond, WA (US)

(21) Appl. No.: 10/934,040

(22) Filed: Sep. 3, 2004

Related U.S. Application Data
(63) Continuation of application No. 09/606,641, filed on Jun. 29, 2000.

(51) Int. Cl. G06F 15/16

(52) U.S. Cl. 709/205

(57) ABSTRACT

A method and system for accessing multiple types of content from a broad range of client program modules. A client program module can access multiple types of content without the client program module having a knowledge of what type of content it is accessing. A user can dynamically add or change services to the system. The method and system can also serve as a standard way of exchanging content between services and client program modules.

### TECHNICAL FIELD

The present invention relates to computer program modules. More specifically, the invention relates a method and system for accessing multiple types of content from a broad range of program modules.

### BACKGROUND OF THE INVENTION

As computer technology has advanced, computer program modules have been used extensively. These program modules have made it possible to work with vast amounts of information in a practical and effective way. Program modules assist in the performance of a specific task, such as word processing, accounting, or inventory management. Although program modules have made information more accessible, the many different program modules available and the increased use of the Internet have caused problems with communications between different program modules. Conventional systems cannot connect content between multiple program modules. This is particularly problematic in the Internet world, because the Internet has caused content to become increasingly convergent with program modules.

In previous computer systems, it has been possible to use one service, or storage area, dedicated to one particular content type. Examples of different content types that can be available in services are images, videos and word processor strings. Because previous computer systems have tied a single service to a single type of content, there has been no level of abstraction that allows multiple services to access multiple content types.

This has been a frustration when accessing the Internet and its multiple program modules and content types. Furthermore, this frustration will continue to increase as future program modules are created with as yet unknown data types. An additional problem has arisen when content needs to be modified or expanded, as it has disrupted the functionality of the service. There has also been no way to combine code and data into one service. In addition, there has been no standard way of exchanging content between services and program modules.

There is a current need in the art for a program module to access multiple content types. There is also a need to access future content types without knowing in advance what those content types will be. There is a need to ensure that a service can be modified or expanded without disrupting the original level of functionality, and without knowing the internal make-up of the service. There is also a need for a standard way of exchanging content between services and program modules.

### SUMMARY OF THE INVENTION

The present invention solves the above problems by providing a method and system for accessing multiple types of electronic content from a broad range of client program modules. A client program module can access multiple types of content without the client program module having a knowledge of what type of content it is accessing. This invention can have the flexibility to allow anything from a dictionary entry to a video to be accessed by any client program module, such as Microsoft Word and Lotus Notes.

The present invention can include a client program module, a core dynamic link library (“DLL”) (including a service manager and a wrapper layer for interfacing with external components), service containers, service objects, a cache file, and a memory storage. Service containers can be arbitrary data containers that can include a code object, an associated data object, and a loader ID. The code object can include service objects. Service objects are reusable object code that can be linked together in different ways. For example, one service container can have a code object that includes service objects A and B. Another service container can have a code object that includes service objects A, C, and D. The loader ID can allow the service manager to access the cache file and instantiate the computer code object and associated data object of the service containers. In this way, multiple types of contents can be activated or run by the service manager. The cache file can contain information on which service containers use the service objects, and service object properties.

In an exemplary embodiment of the present invention, a graphical image and the computer code needed to display the image can be stored in one service container as a first type of content. Meanwhile, text data and its related computer code can be stored in another service container as a second type of content. The service manager can instantiate the code of both the first and second service containers in order to render the graphical image and the text data. Therefore, the service manager can handle an unlimited number of content types. The user does not need to know in advance what types of content will be in the service container because the client program module doesn't need to understand the content to be able to display it. Thus a user can dynamically add services to the system and the client program module that writes to the system doesn't need to know what kind of services will come along in the future. The present invention can also serve as a standard way of exchanging content between services and client program modules.

### BRIEF DESCRIPTION OF THE DRAWINGS

FIG. 1 is a block diagram of a personal computer that provides an exemplary operating environment for an exemplary embodiment of the present invention.

FIG. 2 is a functional block diagram illustrating an exemplary embodiment which can report actions between a client program module, a core DLL, service containers, a cache file, and memory storage.

FIG. 3 is a functional block diagram illustrating yet another exemplary embodiment which can report actions between a word processing application client program module such as Microsoft Word, a service manager, some translation dictionary service containers, a cache file, and memory storage.

FIG. 4 is logical flow diagram illustrating an exemplary method for accessing multiple types of content from a broad range of client program modules as set forth in FIG. 2.

FIG. 5 is a logical flow diagram illustrating an exemplary routine for registering a service by an API method as set forth in FIG. 4.

FIG. 6 is a logical flow diagram illustrating an exemplary routine for registering a service by a setup method as set forth in FIG. 4.

FIG. 7 is a flow diagram illustrating an exemplary method for creating a list of service containers available to the client program module as set forth in FIG. 4.

FIG. 8 is a flow diagram illustrating an exemplary method for creating a service container as set forth in FIG. 4.

### DETAILED DESCRIPTION OF EXEMPLARY EMBODIMENTS

The present invention solves the above problems by providing a method and system for accessing electronic content with a broad range of client program modules. This invention can provide an architecture that allows the entire system to function with any arbitrary client program module. It can have the flexibility to allow anything from a dictionary entry to a video to be accessed by any client program module, such as Microsoft Word and Lotus Notes. Thus, a user can access multiple types of content without the client program module having a knowledge of what type of content it is accessing because the client program module doesn't need to understand the content to be able to display it. Thus, a client program module can access new services to the system because the client program module doesn't need to know what kind of services will come along in the future. In addition, a service can be modified or expanded without disrupting its functionality. In addition, the present invention can provide a standard way of exchanging content between services and client program modules.

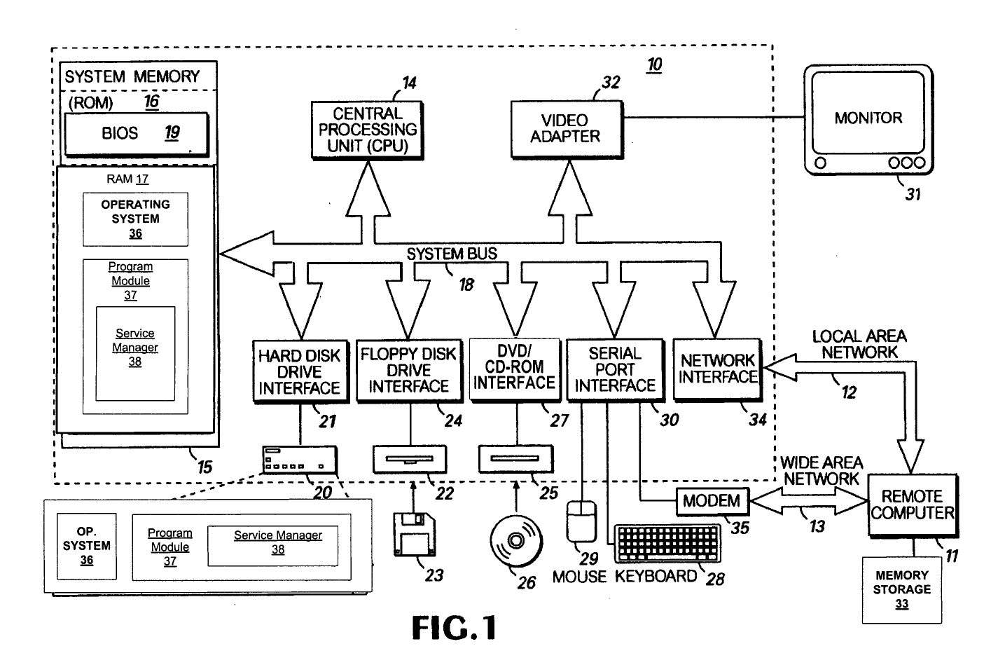

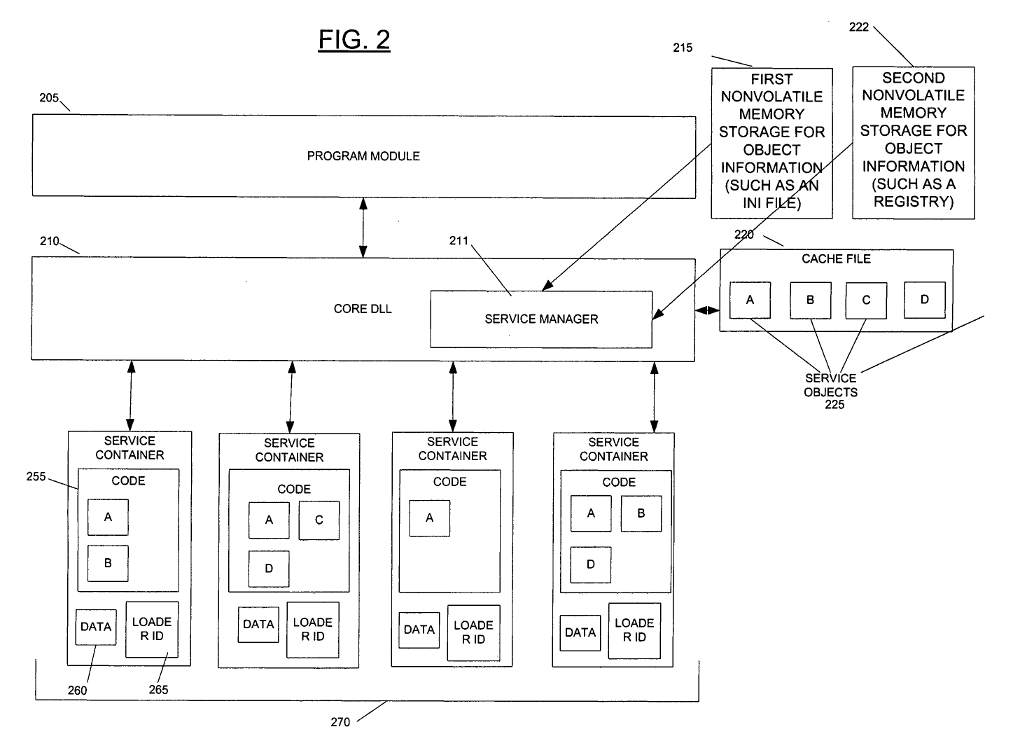

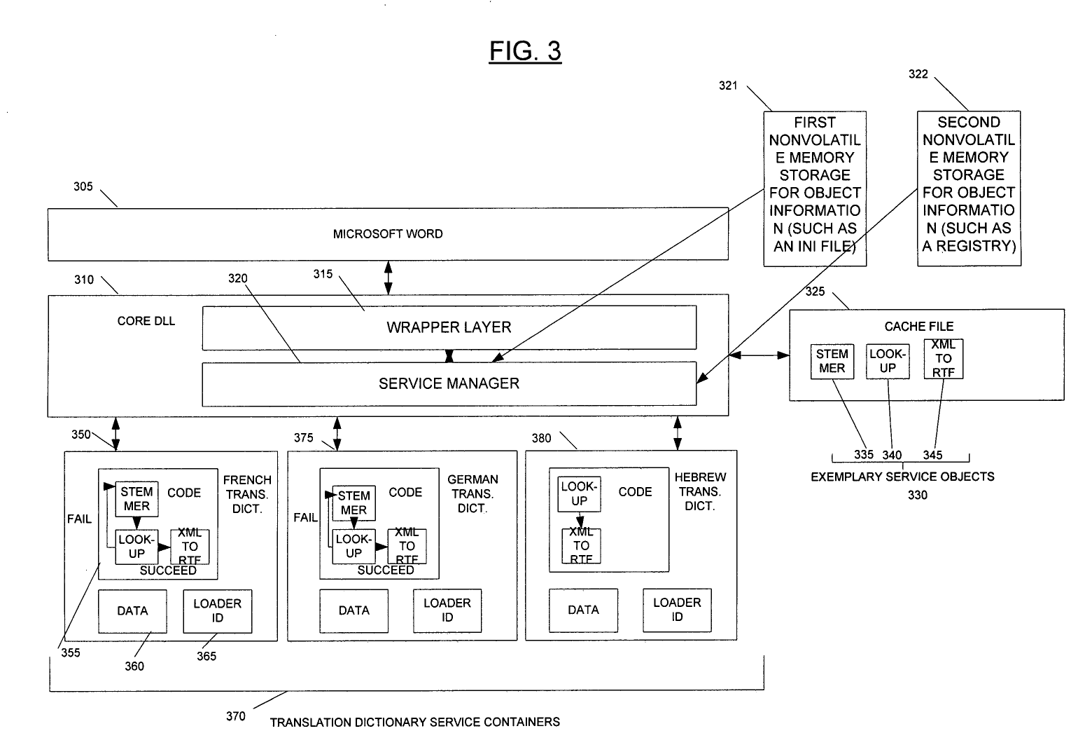

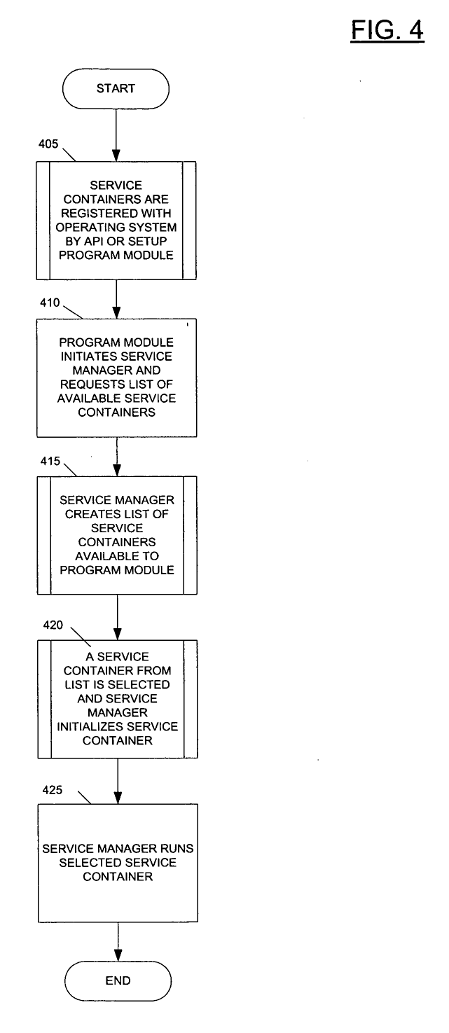

FIG. 1 is a block diagram of a personal computer that provides an exemplary operating environment. FIGS. 2-3 are block diagrams illustrating internal client program module objects. FIG. 4-8 are flow diagrams illustrating an exemplary method for accessing multiple types of electronic content from a broad range of client program modules.

Although an exemplary embodiment will be generally described in the context of a client program module and an operating system running on a personal computer, those skilled in the art will recognize that the present invention also can be implemented in conjunction with other program modules for other types of computers. Furthermore, those skilled in the art will recognize that the present invention may be implemented in a stand-alone or in a distributed computing environment. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the global Internet.

The detailed description which follows is represented largely in terms of processes and symbolic representations of operations by conventional computer components, including a central processing unit (CPU), memory storage devices for the CPU, display devices, and input devices. Furthermore, these processes and operations may utilize conventional computer components in a heterogeneous distributed computing environment, including remote file servers, remote compute servers, and remote memory storage devices. Each of these conventional distributed computing components is accessible by the CPU via a communications network.

The processes and operations performed by the computer include the manipulation of signals by a CPU or remote server and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to these signals as bits, bytes, words, data, objects, properties, flags, types, identifiers, values, elements, symbols, characters, terms, numbers, points, records, images, files or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as comparing, selecting, viewing, getting, giving, etc. which are often associated with manual operations performed by a human operator. The operations described herein are machine operations performed in conjunction with various input provided by a human operator or user that interacts with the computer.

In addition, it should be understood that the program modules, processes, methods, etc. described herein are not related or limited to any particular computer or apparatus, nor are they related or limited to any particular communication network architecture. Rather, various types of general purpose machines may be used with program modules constructed in accordance with the teachings described herein. Similarly, it may prove advantageous to construct a specialized apparatus to perform the method steps described herein by way of dedicated computer systems in a specific network architecture with hardwired logic or program modules stored in nonvolatile memory, such as read only memory.

Referring now to the drawings, in which like numerals represent like elements throughout the several figures, aspects of the present invention and an exemplary operating environment will be described.

The Operating Environment

FIG. 1 illustrates various aspects of an exemplary computing environment in which the present invention is designed to operate. Those skilled in the art will immediately appreciate that FIG. 1 and the associated discussion are intended to provide a brief, general description of an exemplary computer hardware and program modules, and that additional information is readily available in the appropriate programming manuals, user's guides, and similar publications.

FIG. 1 illustrates a conventional personal computer 10 suitable for supporting the operation of an exemplary embodiment of the present invention. As shown in FIG. 1, the personal computer 10 operates in a networked environment with logical connections to a remote computer 11. The logical connections between the personal computer 10 and the remote computer 11 are represented by a local area network 12 and a wide area network 13. Those of ordinary skill in the art will recognize that in this client/server configuration, the remote computer 11 may function as a file server or computer server.

The personal computer 10 includes a central processing unit (CPU) 14. The personal computer also includes system memory 15 (including read only memory (ROM) 16 and random access memory (RAM) 17), which is connected to the CPU 14 by a system bus 18. An exemplary computer 10 utilizes a BIOS 19, which is stored in ROM 16. Those skilled in the art will recognize that the BIOS 19 is a set of basic routines that helps to transfer information between elements within the personal computer 10. Those skilled in the art will also appreciate that the present invention may be implemented on computers having other architectures, such as computers that do not use a BIOS, and those that utilize other microprocessors, such as the “MIPS” or “POWER PC” families of microprocessors from Silicon Graphics and Motorola, respectively.

Within the personal computer 10, a local hard disk drive 20 is connected to the system bus 18 via a hard disk drive interface 21. A floppy disk drive 22, which is used to read or write a floppy disk 23, is connected to the system bus 18 via a floppy disk drive interface 24. A CD-ROM or DVD drive 25, which is used to read a CD-ROM or DVD disk 26, is connected to the system bus 18 via a CD-ROM or DVD interface 27. A user enters commands and information into the personal computer 10 by using input devices, such as a keyboard 28 and/or pointing device, such as a mouse 29, which are connected to the system bus 18 via a serial port interface 30. Other types of pointing devices (not shown in FIG. 1) include track pads, track balls, pens, head trackers, data gloves and other devices suitable for positioning a cursor on a computer monitor 31. The monitor 31 or other kind of display device is connected to the system bus 18 via a video adapter 32.

The remote computer 11 in this networked environment is connected to a remote memory storage device 33. This remote memory storage device 33 is typically a large capacity device such as a hard disk drive, CD-ROM or DVD drive, magneto-optical drive or the like. The personal computer 10 is connected to the remote computer 11 by a network interface 34, which is used to communicate over the local area network 12.

As shown in FIG. 1, the personal computer 10 is also connected to the remote computer 11 by a modem 35, which is used to communicate over the wide area network 13, such as the Internet. The modem 35 is connected to the system bus 18 via the serial port interface 30. The modem 35 also can be connected to the public switched telephone network (PSTN) or community antenna television (CATV) network. Although illustrated in FIG. 1 as external to the personal computer 10, those of ordinary skill in the art will quickly recognize that the modem 35 may also be internal to the personal computer 11, thus communicating directly via the system bus 18. It is important to note that connection to the remote computer 11 via both the local area network 12 and the wide area network 13 is not required, but merely illustrates alternative methods of providing a communication path between the personal computer 10 and the remote computer 11.

Although other internal components of the personal computer 10 are not shown, those of ordinary skill in the art will appreciate that such components and the interconnection between them are well known. Accordingly, additional details concerning the internal construction of the personal computer 10 need not be disclosed in connection with the present invention.

Those skilled in the art will understand that an operating system 36 and a numerous program modules 37 are provided to the personal computer 10 via computer-readable media. In an exemplary computer, the computer-readable media include the local or remote memory storage devices, which may include the local hard disk drive 20, floppy disk 23, CD-ROM or DVD 26, RAM 17, ROM 16, and the remote memory storage device 33. In an exemplary personal computer 10, the local hard disk drive 20 is used to store data and program modules, including the operating system 36 and program modules 37.

The focus of a service manager 38 is described below in a manner that relates to its use in one of the program modules 37 of FIG. 1. This description is intended in all respects to be illustrative rather than restrictive. Alternative embodiments will be apparent to those skilled in the art.

The Internal Objects

Turning now to FIGS. 2-8, exemplary embodiments of the present invention are described. FIG. 2 is a block diagram illustrating internal program module objects of an exemplary embodiment which can report actions between a client program module 205 a core DLL 210 that includes a service manager 211, service containers 270, a cache file 220, a first memory storage 215 such as an initialization (INI) file, and a second memory storage 222 such as a system registry.

The client program module 205 is a sequence of instructions that can be executed by a computer. A client program module 205 typically comprises a word processing program. The core DLL 210 allows executable routines to be stored separately and to be loaded only when needed by the client program module 205. The core DLL of the present invention includes the service manager 211.

The service manager 211 of the present invention can handle arbitrary content by utilizing at least three object methods of the Interface Definition Language in combination with the variant parameter: the exchange method, the set attribute method, and the get attribute method. With the variant parameter and these object methods, the service manager 211 does not need to be limited to known parameters of the data content prior to executing or accessing the data content, rather, the data content or service container 270 defines its own parameters that can be passed to the service manager 211.

The exchange method, set attribute method, and get attribute methods all pass data content. The service containers 270 all share the same interface. The exchange method puts in a variant and takes out a variant. The exchange method allows the client program module 205 to define what kind of data it wants to take out. The set attribute method is used to pass in data content into an object. The get attribute method is used to query an object to get data content.

In an exemplary embodiment, an image (data object 260) and the computer code (code object 255) needed to display the image can be stored in one service container 270 as a first type of content. Meanwhile, text data (data object 260) and the computer code (code object 255) needed to display the text can be stored in another service container 270 as a second type of content. The service manager 211 can instantiate the code of both the first and second content types in order to render both the graphical image as well as the text data. Therefore, the service manager 211 can handle an unlimited number of data types.

Upon selection of an available service container 270, the servicemanager 211 can construct the service container 270. The service manager 211 can connect the client program module 205 to the appropriate service container 270 and in turn the appropriate service objects 225. The service containers 270 can contain a code object 255, an associated data object 260, and a loader ID 265. The code object 255 can consist of service objects 225 that perform specific functions and that provide support to the client program module 205. Service containers 270 can be temporary arrangement of reusable service objects 225. The service objects 225 can be used by multiple service containers 270, can interact with one another, and can have predefined relationships relative to one another. In an exemplary aspect of the present invention, the service objects 225 can be linked to one another in an “object-chaining” relationship where the service objects 225 must be run in a particular order. In addition, each service object 225 can have a more dependent relationship with another service object 225 within the chain. This is a “master-slave” relationship where one service object 225 is dependent on the output of another service object 225. During execution of an object chain, a “master” object can pause the output of a service object 225 by continuously checking and accessing the output of a “slave” object until the output of the “slave” object reaches a desired threshold or value.

The cache file 220 can be a local collection of all the service objects 225 and properties of service objects 225 that enable the service manager 211 to create service containers 270 and service objects 225 very quickly. The cache file 220 can contain information on which service containers 270 use the service objects 225, as well as service object property information. The cache file 220 can store a version of an initialization (“INI”) file that denotes the object properties, object names, object descriptions, object chain IDs. privilege IDs, objects within each object chain (where an object chain denotes a service), and properties for each object.

The service manager 211 can make sure the cache file 220 matches the second memory storage (or registry) 222. With the loader ID 265, the service manager 211 can access the cache file 220 and instantiate the code object 255 and data object 250 of the service containers 270. In this way, multiple types of contents can be activated or run by the service manager 211. Additional service containers 270 can also be accessed without modifying the service manager's 211 existing programming architecture. In fact, the service manager 211 does not need to know in advance what types of data content it can access.

The second memory storage (or registry) 222 is a non-volatile memory storage for object information. It is a central hierarchical database used in a Windows operating environment that contains information which is continuously accessed during operation. The second memory storage (or registry) 222 can store system-wide information, including information on what kind of service containers 270 are installed. In one exemplary embodiment, the second memory storage (or registry) 222 can contain loader IDs 265 for loaders. Loaders are used to access data objects stored on a particular type of storage medium.

The memory storage 215 is a nonvolatile memory storage for object information such as an INI file. An INI file 215 can denote the object properties, object names, object descriptions, object chain IDs, privilege IDs, objects within each object chain (where an object chain denotes a service), and properties for each object.

FIG. 3 is a block diagram illustrating internal program module objects of an exemplary embodiment which can report actions between Microsoft Word 305, a core DLL 310, some translation dictionary service containers 370, a cache file 325, a first nonvolatile memory storage such as in INI file 215, and a second nonvolatile memory storage such as a registry 222. The core DLL 310 can be the interface of the translation dictionary service containers 370. It includes the service manager 320 and a wrapper layer 315. The service manager 320 can connect the translation dictionary services containers 370 to the wrapper layer 315, and in turn to the Microsoft Word 305. The wrapper layer 315 allows the service manager to be accessible to a client program module 205 such as Microsoft Word 305 using an interface supported by that client program module 205. The service manager 320 can perform service installation, service cataloging, and service access control. A service container 370 can be installed by an API or a setup program module. A service catalogue, created by the service manager 320, can list services available to Microsoft Word 305 based on Microsoft Word's 305 privileges.

The translation dictionary service containers 370 can include a code object 355, a data object 360, and a loader ID 365. The data object 360 in this embodiment can be lexical data. The code object 355 can consist of service objects 330 that perform language-specific functions. The loader ID 365 is a generic interface that can be re-used for any type of data exchange. The loader ID 365 can be passed to the service manager 320. The loader ID 365 can tell the service manager 320 what type of loader should be used to load a specific service object 330.

In an exemplary embodiment, the translation dictionary service containers 370 can include a French translation dictionary 350, a German translation dictionary 375, and a Hebrew translation dictionary 380. The service objects 330 can include a stemmer 335, a look-up 340, and an extensible mark-up language (xml) to rich text format (rtf) or “xml to rtf” object 345. The stemmer 335, look-up 340 and “xml to rtf” 345 objects can demonstrate both the “object-chaining” and “master-slave” relationships.

For example, if the user enters the English word “loves” and desires a French translation, the service manager 320 can create or instantiate the French translation dictionary 350. The stemmer 335 object of the French translation dictionary 350 can take the word “loves” and truncate the suffix from the base word “love”. The look-up object 340 then can look up the word “love” in French. If there is not a matching definition in the look-up dictionary, the stemmer object 335 can continue to truncate the word and pass the truncated word to the look-up 340 until the look-up 340 finds a definition in the dictionary. In this scenario, the look-up object 340 can be a “master” object while the stemmer object 335 can be a “slave” object to the “master” look-up object 340. The look-up object 340 can continue to use the stemmer object 335 to truncate a word until a definition is found. Once there is a matching definition for the stem, the “xml to rtf” object 345 can change the format of the data from extensible markup language to rich text format. The particular order of running the stemmer 335, look-up 340 and “xml to rtf” 345 objects illustrates one example of an “object-chaining” relationship. As noted above, the relationship between the stemmer 335 and the look-up 340 object exemplifies a “master-slave” relationship where the stemmer object 335 is a “slave” to the “master” look-up object 340. The different service objects 330 can be reused in many translation dictionary service containers 370. Thus, the French 350 and German translation dictionary 375 can both include a stemmer object 335, a look-up object 340, and/or an “xml to rtf” object 345, or any combination of fewer or more service objects 330 thereof.

Overview of Accessing Content from a Broad Range of Program Modules

FIG. 4 is flow diagram illustrating an exemplary method for accessing multiple types of content from a broad range of client program modules 205 as set forth in FIG. 2. In routine 405, the service containers 270 can be registered with the operating system 36 by an API or a setup program module. In step 410, the client program module 205 can initiate the service manager 211 and can request a list of available service containers 270. The service manager 211 can check the client program module's global universal identification (“GUID”) privilege key and can find the service containers 270 that have the same GUID privilege key. The service manager 211 can only enumerate the service objects 225 in the service containers 270 that the client has access to based on the GUID privilege key. These matching service objects 225 and service containers 270 can be available to the client program module 205. In routine 415, the service manager 211 can create a list of service containers 270 and service objects 225 available to the client program module 205.

In routine 420, service containers 270 from the list can be selected and created by the service manager 211. The service manager 211 can create the service containers by loading the service objects 225 into the service containers 270. In creating the service objects 225, the service manager 211 can load service object properties from the service object list or catalogue containing information on the relationships of “object-chaining”, “master-slave” and how to instantiate objects.

In step 425, the service manager can run the service objects 225 in the selected service containers 270.

In one exemplary embodiment of the present invention, Microsoft Word 305 can be the client program module 205 that instantiates the service manager 320 and requests the list of available translation dictionaries service containers 370. The service manager 320 can find out the French Translation Dictionary 350, the German Translation Dictionary 375, and the Hebrew Translation Dictionary 380 are available to Microsoft Word 305. Microsoft Word 305 then can request the service manager 320 to instantiate the service objects 330 that form the available translation dictionary service containers 370. The stemmer 335, the look-up 340, and the “xml to rtf” 345 objects can be some of the service objects 330 contained in the French Translation Dictionary 350. The stemmer 335, the look-up 340, and the “xml to rtf” 345 objects can be some of the service objects 330 contained in the German Translation Dictionary 375. And the “xml to rtf” object 345 can be one of the service objects 330 contained in the Hebrew Translation Dictionary 380.

Registering Services

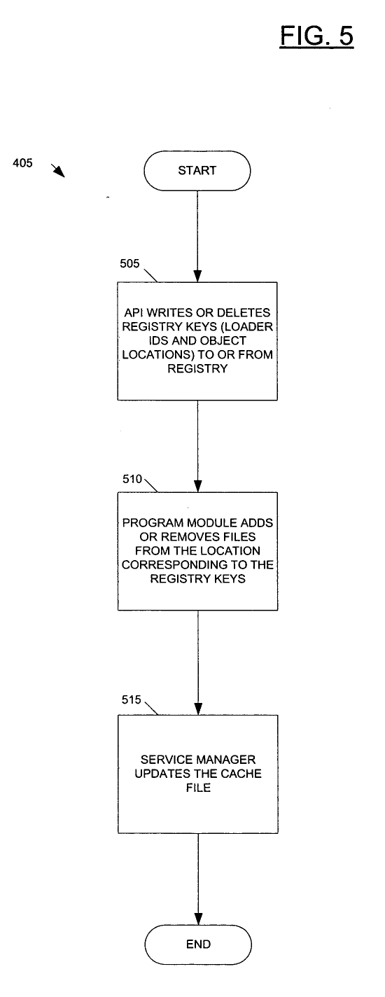

FIG. 5 is a flow diagram illustrating an exemplary routine 405 for registering a service container 270 by an API method as set forth in FIG. 4. Registering a service container 270 can entail installing the service container 270 as part of the operating system 36. In an exemplary embodiment, the user can install Microsoft Word 305 and select the translation dictionary service container 370 as something that the user wants in Microsoft Word 305. The translation dictionary service container 370 can be installed as part of installing Microsoft Word 305 and the installation can populate the second memory storage (or registry) 222 with information about the translation dictionary service container 370.

This method can allow a service container 270 to be installed and to have its presence written to the second memory storage (or registry) 222 and to the cache file 220 at install time instead of during the first instantiation. Referring to FIG. 5, in step 505, an API can write or delete registry keys (loader IDs 265 and object locations) to or from the second memory storage (or registry) 222. In step 510, the client program module 205 can add or remove files from the appropriate location corresponding to the registry keys. In step 515, the service manager 211 can update the cache file 220. The cache file 220 can contain information about which service containers 270 use which service objects 225, and service object properties. This information can help allow the service containers 270 to be loaded quickly.

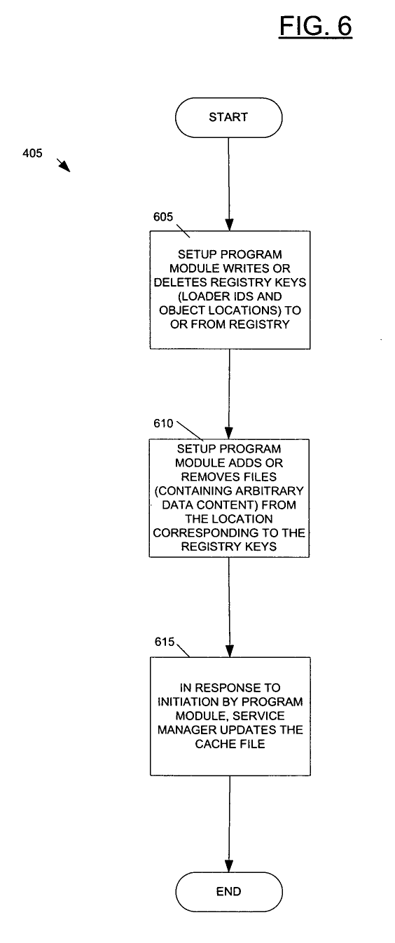

FIG. 6 is a flow diagram illustrating an exemplary routine 405 for registering a service container 270 by a setup program module as set forth in FIG. 4. The setup program module can write entries into the second memory storage (or registry) 222 that define the service containers 270 and define the loader IDs 265. In other words, the second memory storage (or registry) 222 can tell the program module 205 how to load the service container 270 and its service objects 225 by giving a loader ID 265 interface. Then it can be the loader's responsibility to load the particular service object 225 identified with it in the second memory storage (or registry) 222. This method can put the object files in the right location and then can put the information in the second memory storage (or registry) 222. In step 605, the setup program module can write or delete registry keys (loader IDs 265 and object locations) to or from the second memory storage (or registry) 222. In step 610, the setup program module can add or remove the object files (containing arbitrary data content) from the appropriate location corresponding to the registry keys. In step 615, in response to initiation by the client program module 205, the service manager 211 can update the cache file 220 that can contain the list of available service containers 270.

Creating a List of Service Containers

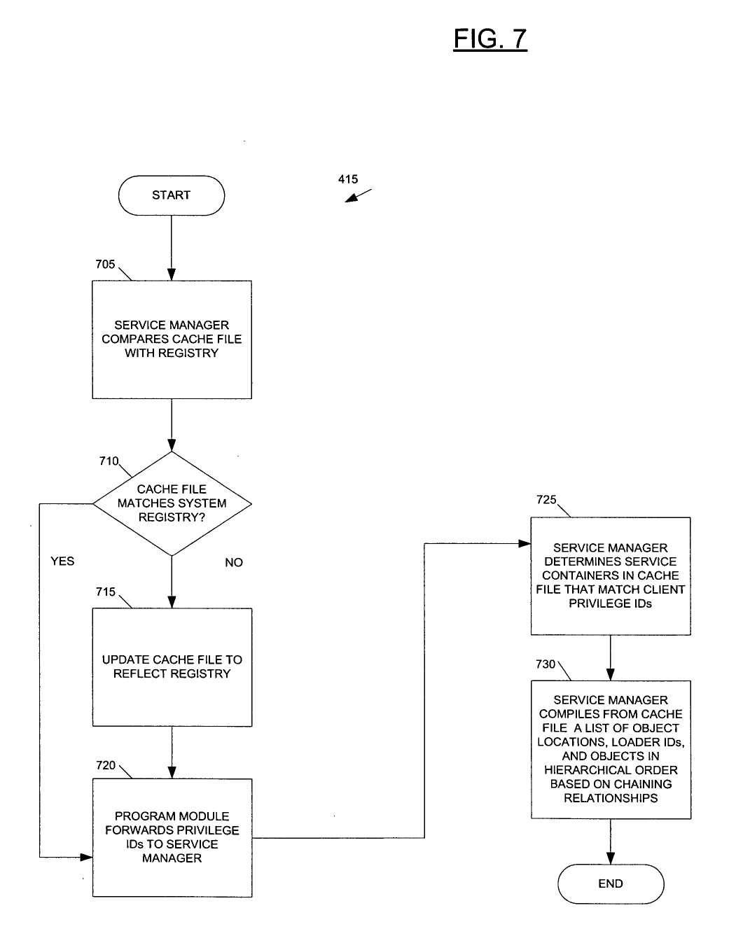

FIG. 7 is a flow diagram illustrating an exemplary routine 415 for creating a list of service containers 270 available to the client program module 205 as set forth in FIG. 4. In step 705, the service manager 211 can compare the cache file 220 with the second memory storage (or registry) 222. In decision 710, it can be determined if the cache file 220 matches the second memory storage (or registry) 222. If the inquiry of decision step 710 is negative, then the cache file 220 can be updated to reflect the second memory storage (or registry) 222, as set forth in step 715. If the inquiry to decision step 710 is positive, then the “yes” branch is followed to step 720. In step 720, the client program module 205 can forward privilege data to the service manager 211. In step 725, the service manager 211 can determine the service containers 270 in the cache file 220 that match the client privilege data. The cache file 220 can contain a list of all the properties of all the service containers 270 and service objects 225. So in this step, the service manager 211 can access the cache file 220 and can review the properties of each service container 270. Then the service manager 211 can look at the privilege attributes of the service object chain and when there is a match of loader IDs 265 the service manager 211 can grant the client program module 205 access to that service container 270. The service manager 211 can do this in succession for all the service containers 270 the client program module 205 can access. In step 730, the service manager 211 can compile from the cache file 220 a list of object locations, loader IDs 265 and service objects 225 in a hierarchical order based on chaining relationships. In this step, the service manager 211 can go to the second memory storage (or registry) 222 and locate the loader ID 265 and the loader ID 265 can then access a table of properties for each selected service object 225 and load that service object 225 as its property. Thus the second memory storage (or registry) 222 can point the service manager 211 to the correct place of the properties and objects. The hierarchical order can be formulated from an INI file 215. When the service manager 211 is used, it first can validate if there are any new contents or content deletes or updates by checking the INI file 215. The service manager 211 can then update the cache file 220 by using the INI file 215.

Creative Service Containers

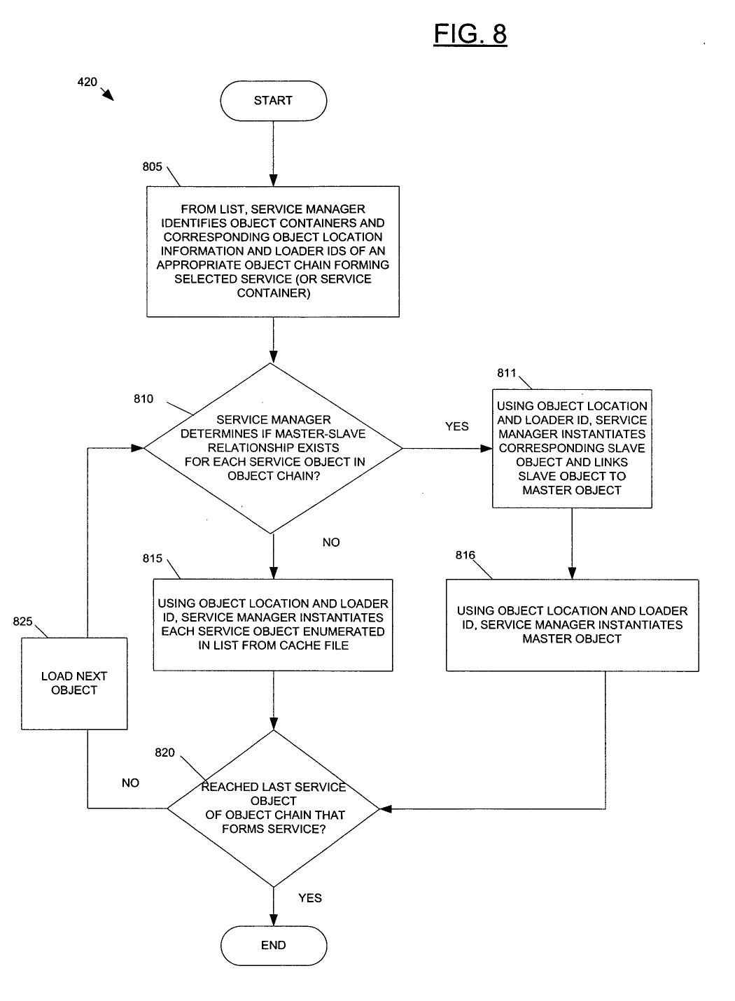

FIG. 8 is a flow diagram illustrating an exemplary routine 420 for creating a service container 270 and service objects 225 as set forth in FIG. 4. In step 805, from the list generated in step 730 of FIG. 7, the service manager 211 can identify service objects 225 and corresponding object location information and loader IDs 265 of an appropriate object chain forming a selected service container 270. In decision step 810, the service manager 211 can determine if a “master-slave” relationship exists for each service object 225 in the object chain. If the inquiry to decision step 810 is positive, then the “yes” branch can be followed to step 811. In step 811, using the object location and loader ID 265, the service manager 211 can instantiate the corresponding “slave” object and can link the “slave” object to the “master” object. In step 816, using the object location and loader ID 265, the service manager 211 can instantiate the “master” object. If the inquiry to decision step 810 is negative then the “no” branch can be followed to step 815. In step 815, using the object location and loader ID 265, the service manager 211 can instantiate each object enumerated in the list from the cache file 220. In decision step 820, it can determine if the last object of the object chain that forms the service container 270 and service objects 225 is reached. If the inquiry to decision step 820 is negative, then the “no” branch can be followed to step 825 in which the next object can be loaded.

Loader IDs 265 inform the service manager 211 of the type of loader to use to access the data for a specific service object 330. A loader is a software mechanism that assists the service manager 211 to load data from a specific type of storage medium. A loader can be designed to help the service manager 211 load data from storage media such as magnetic floppy disks, optical media like CD-ROMs or DVDs, or data downloadable from a wide area network, such as the Internet. Usually, separate loaders exists for each type of storage medium that may contain service object data.

In an exemplary embodiment, the French translation dictionary 350 can have the following “object-chaining” order: the stemmer object 335, the look-up object 340, and the “xml to rtf” object 345. A “master-slave” relationship can exist between the stemmer object 335 and the look-up object 340, where the stemmer object 335 is a “slave” to the “master” look-up object 340. The service manager 320 can load information into a table that indicates that the stemmer object 335 is run before the lookup object 340, and the lookup object 340 is run before the “xml to rtf” object 345. The service manager 320 also can load information that indicates that the look-up object 340 is the “master” to the “slave” stemmer object 335. Microsoft Word 305 then can request the service manager 320 to instantiate each object of the desired translation dictionary service container 370 in the list. The service manager 320 then can check to see if a “master-slave” relationship exists for any of the service objects in these translation dictionary service containers 370. If yes, the service manager 320 can record the relationship. Because there is a “master-slave” relationship with the stemmer 335 and look-up 340 objects, the service manager 320 can record this. The service manager 320 then can move onto the first service 330 object in the list of chaining and can instantiate this service object 330. In this case, this can be the stemmer object 335, which has the look-up object 340 as its “master”. The service manager thus can instantiate the “slave” stemmer object 335 before the “master” look-up object 340. The service manager 320 then can repeat the above steps until it reaches the last service object 330 in the list.

The present invention has been described in relation to particular embodiments which are intended in all respects to be illustrative rather than restrictive. Alternative embodiments will become apparent to those skilled in the art to which the present invention pertains without departing from its spirit and scope. Accordingly, the scope of the present invention is defined by the appended claims rather than the foregoing description.

1-20. (Cancelled)

21. A method of enabling a client program module to access one or more service containers that provide a total data content unknown to the client program module and not expected to be accessed by the client program module when the client program module was created, one or more service containers providing at least a partial data content that is unknown to the client program module, comprising the steps of:
(a) requesting a list of available service containers;
(b) creating the list of available service containers based on a common access privilege between the client program module and each service container;
(c) selecting a service container from the list of available service containers, wherein the service container selected includes the at least partial data content unknown to the client program module; and
(d) if the access to the at least partial data content enables the program module to access the total data content in the service container that was selected:
(i) initializing the service container selected such that the client program module is enabled to access and use the total data content; else
(ii) selecting an other service container from the list of available service containers that comprises at least further partial data content unknown to the client program module and initializing the other service container selected such that the client program module is enabled to access and use the further partial data content of the other service container selected, and repeating this step as needed until the client program manager is enabled to access and use the total data content of the service containers selected.

22. The method of claim 21, further comprising the step of registering the service containers, which includes the steps of:
(a) writing loader identifications and object locations to a registry;
(b) adding files from the location corresponding to the loader identifications and object locations; and
(c) updating a cache file.

23. The method of claim 21, further comprising the step of initiating a service manager, which responds to a request for the list of available service containers by creating the list of available service containers.

24. The method of claim 21, wherein the step of creating the list of available service containers comprises the steps of:
(a) comparing privilege data of the client program module with privilege data of objects stored in a storage medium; and
(b) in response to a match between the privilege data of the client program module with the privilege data of the objects, recording each respective match in the list.

25. The method of claim 21, wherein the step of creating the list of available service containers comprises the steps of:
(a) comparing a cache file with a registry;
(b) updating the cache file to reflect the registry, if the cache file does not match the registry;
(c) determining services in the cache file that match a privilege identification of the client program module; and
(d) compiling a list of object locations, loader identification data, and objects in hierarchical order, from the cache file.

26. The method of claim 21, wherein the step of initializing the service container selected comprises the step of loading a plurality of service objects that comprise the service container selected.

27. The method of claim 26, wherein the service objects have a predefined relationship that includes one of the following:
(a) the service objects must be executed in a predefined order; and
(b) the service objects are in a master-slave relationship.

28. The method of claim 21, wherein the service container comprises at least one of:
(a) a code object that performs a specific function;
(b) an associated data object; and
(c) a loader identification.

29. The method of claim 21, wherein a service container that provides foreign language translation functionality as the at least partial data content comprises:
(a) a stemmer object;
(b) a look-up object; and
(c) a character set conversion object.

30. The method of claim 21, wherein the step of initializing comprises the step of managing one or more service containers such that the at least partial data content of each service container is passed bi-directionally between the service manager, the service container, a cache file, and the client program module, using a variant parameter and one of the following:
(a) a first method wherein a first variant parameter is input to the service container by the service manager and a second variant parameter is output from the service container to the service manager;
(b) a second method wherein the at least partial data content is passed into an object; and
(c) a third method wherein the at least partial data content is received by querying an object.

31. The method of claim 21, further comprising the step of instantiating the at least partial data content from one or more service containers using a cache file such that the total data content is accessed in the cache file.

32. A memory medium having machine executable instructions for carrying out the steps of claim 21.

33. A system that enables a client program module to access one or more service containers that provide a total data content unknown to the client program module and not expected to be accessed by the client program module when the client program module was created, one or more service containers providing at least a partial data content that is unknown to the client program module, comprising:
(a) a processor; and
(b) a memory coupled to the processor, the memory storing machine instructions causing the processor to:
(i) enable the client program module to request a list of available service containers;
(ii) create the list of available service containers based on a common access privilege between the client program module and each service container;
(iii) select a service container from the list of available service containers, wherein the service container selected includes the at least partial data content unknown to the client program module; and
(iv) if the access to the at least partial data content enables the program module to access the total data content in the service container that was selected:
(1) initialize the service container selected such that the client program module is enabled to access and use the total data content; else
(2) select an other service container from the list of available service containers that comprises at least further partial data content unknown to the client program module and initialize the other service container selected such that the client program module is enabled to access and use the further partial data content of the other service container selected, and repeat this step as needed until the client program manager is enabled to access and use the total data content of the service containers selected.

34. The system of claim 33, wherein the machine instructions further cause the processor to register the service containers, by:
(a) writing loader identifications and object locations to a registry maintained in the memory;
(b) adding files from the location corresponding to the loader identifications and object locations; and
(c) updating a cache file in the memory.

35. The system of claim 33, wherein the machine instructions further cause the processor to initiate a service manager, which responds to a request for the list of available service containers by creating the list of available service containers.

36. The system of claim 33, wherein the machine instructions further cause the processor to:
(a) compare privilege data of the client program module with privilege data of objects stored in a storage medium; and
(b) in response to a match between the privilege data of the client program module with the privilege data of the objects, record each respective match in the list.

37. The system of claim 33, wherein the machine instructions further cause the processor to:
(a) compare a cache file with a registry maintained in the memory;
(b) update the cache file to reflect the registry, if the cache file does not match the registry;
(c) determine services in the cache file that match a privilege identification of the client program module; and
(d) compile a list of object locations, loader identification data, and objects in hierarchical order, from the cache file.

38. The system of claim 33, wherein the machine instructions further cause the processor to load a plurality of service objects that comprise the service container selected.

39. The system of claim 38, wherein the service objects have a predefined relationship that includes one of the following:
(a) the service objects must be executed by the processor in a predefined order; and
(b) the service objects are in a master-slave relationship.

40. The system of claim 33, wherein the service container comprises at least one of:
(a) a code object that performs a specific function;
(b) an associated data object; and
(c) a loader identification.

41. The system of claim 33, wherein a service container that provides foreign language translation functionality as the at least partial data content comprises:
(a) a stemmer object;
(b) a look-up object; and
(c) a character set conversion object.

42. The system of claim 33, wherein when the machine instructions further cause the processor to manage one or more service containers such that the at least partial data content of each service container is passed bi-directionally between the service manager, the service container, a cache file, and the client program module, using a variant parameter and one of the following:
(a) a first method wherein a first variant parameter is input to the service container by the service manager and a second variant parameter is output from the service container to the service manager;
(b) a second method wherein the at least partial data content is passed into an object; and
(c) a third method wherein the at least partial data content is received by querying an object.

43. The system of claim 33, wherein the machine instructions further cause the processor to instantiate the at least partial data content from one or more service containers using a cache file such that the total data content is accessed in the cache file.
